(19) United States
(12) Patent Application Publication
(10) Pub. No.: US 2018/0368053 A1
(43) Pub. Date: Dec. 20, 2018

(54) METHOD AND DEVICE FOR NETWORK SLICING

(71) Applicants: HON HAI PRECISION INDUSTRY CO., LTD., New Taipei (TW); NATIONAL TAIWAN UNIVERSITY, Taipei (TW)

(72) Inventors: HUNG-YU WEI, Taipei (TW); CHING-CHUN CHOU, Taipei (TW)

(21) Appl. No.: 16/009,215

(22) Filed: Jun. 15, 2018

Related U.S. Application Data
(60) Provisional application No. 62/520,253, filed on Jun. 15, 2017.

(51) Int. Cl. H04W 48/10; H04W 48/14; H04W 48/18; H04W 4/06; H04W 8/24

(52) U.S. Cl. CPC H04W 48/10; H04W 48/14; H04W 8/245; H04W 4/06; H04W 48/18

(57) ABSTRACT

Methods and devices for network slicing are disclosed. The method of network slicing includes generating, by a base station, a network slice capability message including a network slice profile having a computational configuration, and transmitting, by the base station, the network slice capability message to a user equipment (UE).

### CROSS-REFERENCE TO RELAYED APPLICATIONS

The present application claims the benefit of and priority to a provisional U.S. Patent Application Ser. No. 62/520253 filed Jun. 15, 2017, entitled “METHOD FOR NETWORK SLICING CONFIGURATION,” Attorney Docket No. US70922 (hereinafter referred to as “US70922 application”). The disclosure of the US70922 application is hereby incorporated fully by reference into the present application.

### TECHNICAL FIELD

The present disclosure generally relates to wireless communication, and more particularly, to methods and devices for network slicing.

### BACKGROUND

Network slicing is one of the key features in the 5^{th} generation (5G) communication technology in which a single physical network can be subdivided into multiple virtual networks (e.g., network slices). Network slicing technology provides great flexibility of network resource utilization, allowing a network operator to provide dedicated virtual networks to serve the needs of various users over a common physical network infrastructure.

One noticeable feature of network slicing is the ability to provide customized services to specific users. For example, a network operator can provide a network slice with ultra-reliable service to a user, and provide a network slice with ultra-high-bandwidth communication to another user. The current discussion on the network slicing technology focuses on providing network slices for communication and networking. However, there is a need in the art for an improved network slicing signaling mechanism to improve the performance and extend the flexibility of network slicing.

### SUMMARY

The present disclosure is directed to methods and devices for network slicing.

According to an aspect of the present disclosure, a method for network slicing is provided. The method of network slicing includes generating, by a base station, a network slice capability message including a network slice profile containing a computational configuration; and transmitting, by the base station, the network slice capability message to a user equipment (UE).

According to another aspect of the present disclosure, a method for network slicing is provided. The method of network slicing includes receiving, by a UE, a network slice capability message from a base station, wherein the network slice capability message includes a network slice profile including a computational configuration; and establishing, by the UE, a connection to a network slice in response to the network slice capability message.

According to another aspect of the present disclosure, a base station is provided. The base station includes one or more non-transitory computer-readable media having computer-executable instructions embodied thereon and at least one processor coupled to the one or more non-transitory computer-readable media. The at least one processor is configured to execute the computer-executable instructions to generate a network slice capability message including a network slice profile, wherein the network slice profile includes a computational configuration, and transmit the network slice capability message to a user equipment UE.

According to another aspect of the present disclosure, a UE is provided. The UE includes one or more non-transitory computer-readable media having computer-executable instructions embodied thereon and at least one processor coupled to the one or more non-transitory computer-readable media. The at least one processor is configured to execute the computer-executable instructions to receive a network slice capability message from a base station, wherein the network slice capability message includes a network slice profile including a computational configuration, and establish a connection to a network slice in response to the network slice capability message.

### BRIEF DESCRIPTION OF THE DRAWINGS

Aspects of the exemplary disclosure are best understood from the following detailed description when read with the accompanying figures. Various features are not drawn to scale, dimensions of various features may be arbitrarily increased or reduced for clarity of discussion.

FIG. 1 is a diagram illustrating a method for network slicing, in accordance with an example implementation of the present disclosure.

FIG. 2 is a diagram illustrating a method for network slicing, in accordance with an example implementation of the present disclosure.

FIG. 3 is a diagram illustrating a method for network slicing during a transmission procedure of network slice capability messages, in accordance with an example implementation of the present disclosure.

FIG. 4 is a diagram illustrating a method for network slicing during a transmission procedure of network slice capability messages, in accordance with an example implementation of the present disclosure.

FIG. 5 is a diagram illustrating a method for network slicing during a transmission procedure of network slice capability messages, in accordance with an example implementation of the present disclosure.

FIG. 6 is a block diagram of a node for wireless communication, in accordance with various aspects of the present application.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

For the purpose of consistency and ease of understanding, like features are identified (although, in some examples, not shown) by numerals in the example figures. However, the features in different implementations may be differed in other respects, and thus shall not be narrowly confined to what is shown in the figures.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent.

Additionally, for the purposes of explanation and non-limitation, specific details, such as functional entities, techniques, protocols, standard, and the like are set forth for providing an understanding of the described technology. In other examples, detailed description of well-known methods, technologies, system, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules may be software, hardware, firmware, or any combination thereof. The software implementation may comprise computer executable instructions stored on computer readable medium such as memory or other type of storage devices. For example, one or more microprocessors or general purpose computers with communication processing capability may be programmed with corresponding executable instructions and carry out the described network function(s) or algorithm(s). The microprocessors or general purpose computers may be formed of applications specific integrated circuitry (ASIC), programmable logic arrays, and/or using one or more digital signal processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to random access memory (RAM), read only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-readable instructions.

A radio communication network architecture (e.g., a long term evolution (LTE) system, a LTE-Advanced (LTE-A) system, or a LTE-Advanced Pro system) typically includes at least one base station, at least one UE, and one or more optional network elements that provide connection towards a network. The UE communicates with the network (e.g., a core network (CN), an evolved packet core (EPC) network, an Evolved Universal Terrestrial Radio Access network (E-UTRAN), a Next-Generation Core (NGC), or an internet), through a radio access network (RAN) established by the base station.

It should be noted that, in the present application, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, or a personal digital assistant (PDA) with wireless communication capability. The UE is configured to receive and transmit signals over an air interface to one or more cells in a radio access network.

A base station may include, but is not limited to, a node B (NB) as in the UMTS, an evolved node B (eNB) as in the LTE-A, a radio network controller (RNC) as in the UMTS, a base station controller (BSC) as in the GSM/GERAN, an NG-eNB as in an E-UTRA base station in connection with the 5GC, a next generation node B (gNB) as in the 5G-AN, and any other apparatus capable of controlling radio communication and managing radio resources within a cell. The base station may connect to serve the one or more UEs through a radio interface to the network.

A base station may be configured to provide communication services according to at least one of the following radio access technologies (RATs): Worldwide Interoperability for Microwave Access (WiMAX), Global System for Mobile communications (GSM, often referred to as 2G), GSM EDGE radio access Network (GERAN), General Packet Radio Service (GRPS), Universal Mobile Telecommunication System (UMTS, often referred to as 3G) based on basic wideband-code division multiple access (W-CDMA), high-speed packet access (HSPA), LTE, LTE-A, eLTE (evolved LTE), New Radio (NR, often referred to as 5G), and/or LTE-A Pro. However, the scope of the present application should not be limited to the above mentioned protocols.

The base station is operable to provide radio coverage to a specific geographical area using a plurality of cells forming the radio access network. The base station supports the operations of the cells. Each cell is operable to provide services to at least one UE within its radio coverage. More specifically, each cell (often referred to as a serving cell) provides services to serve one or more UEs within its radio coverage, (e.g., each cell schedules the downlink and optionally uplink resources to at least one UE within its radio coverage for downlink and optionally uplink packet transmissions). The base station can communicate with one or more UEs in the radio communication system through the plurality of cells. A cell may allocate sidelink (SL) resources for supporting proximity service (ProSe). Each cell may have overlapped coverage areas with other cells.

As discussed above, the frame structure for NR is to support flexible configurations for accommodating various next generation (e.g., 5G) communication requirements, such as enhanced mobile broadband (eMBB), massive machine type communication (mMTC), ultra-reliable communication and low latency communication (URLLC), while fulfilling high reliability, high data rate and low latency requirements. The orthogonal frequency-division multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP), may also be used. Additionally, two coding schemes are considered for NR: (1) low-density parity-check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resource may also be provided in an NR frame to support ProSe services.

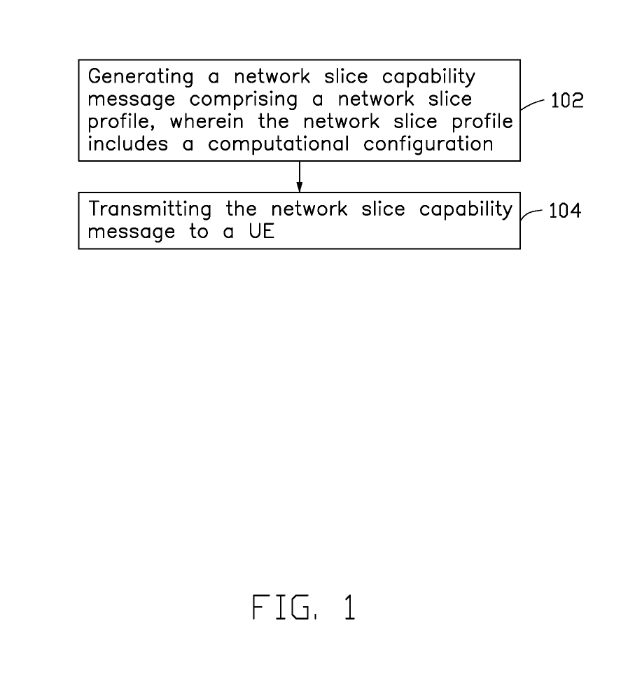

FIG. 1 is a diagram illustrating a method for network slicing, in accordance with an example implementation of the present disclosure. In action 102, the base station generates a network slice capability message. The network slice capability message may include a network slice profile having a computational configuration. In action 104, the base station transmits the network slice capability message to a UE. In one implementation, the network slice capability message may include all available network slice profiles. In another implementation, the network slice capability message may include one or more network profiles indicated/requested by the UE.

A network slice profile may correspond to a network slice. For example, a network operator or a service provider may provide multiple network slices for various use cases, and define the network slice by a corresponding network slice profile. In other words, the network slice may be configured with a corresponding network slice profile to support one or more network functions.

In one implementation, at least one network slice profile contained in the network slice capability message may include a computational configuration. For example, the computational configuration may be instantiated based on various kinds of computational services, such as edge computing services, cloud computing services, edge-cloud hybrid computing services.

In another implementation, the computational configuration may include at least one processing node type for a service. The processing node type may indicate, explicitly or implicitly, which type of the processing node (e.g., an edge node (e.g., a

Mobile Edge Computing (MEC) node, a fog node), a cloud node or a hybrid node) may handle the computational service. For example, the processing node type may be realized as a flag to indicate whether the computational service is done in an edge node only, done in a cloud node only, or done in a hybrid node including both the edge node and the cloud node. For example, the processing node type may be a binary flag, where “1” (or “0”) means that the computational service is done in the edge node only, and “0” (or “1”) means that the network slice is instantiated to support cloud computing service or edge-cloud hybrid computing service.

In some implementations, the processing node type may be realized as a type identifier that explicitly indicate a certain type of the processing node. For example, the type identifier may indicate at least one of the following: (1) the computational service is handled by the edge node only; (2) the computational service is handled by the cloud node only; (3) the computational service is handled by either the edge node or the cloud node; and (4) the computational service is handled by both the edge node and the cloud node. In some implementations, the type identifier may further indicate whether a guarantee of service performance (e.g., maximum service delay bound, Service Level Agreement (SLA) requirement) is provided with the processing node.

In some implementations, the computational configuration may include a service type. The service type may indicate whether a computational processing, an application processing, or both is included in a service. In one implementation, the computational processing refers to computational tasks performed by the network node (e.g., an edge node, a fog node, a cloud node or a hybrid node), while the application processing refers to application tasks performed by the service provider. Take a Virtual Reality (VR) use case for example, 3D object computational tasks are performed by the network node, the video application tasks are performed by the service provider (e.g., YouTube), and therefore both the computational processing and the application processing are included. In one implementation, the service type may be realized as a flag to indicate whether the application processing/computational processing is included in the service.

In some other implementations, the computational configuration may include a service provider identifier for a service. The service provider identifier may explicitly or implicitly indicate at least one service provider or network operator that provides the administrative domain for the network slice. For example, the service provider identifier may indicate whether the computational service is all within the administrative domain of a network operator, or involves a 3^{th} party application service provider.

In one implementation, the network slice profile may further include a security credential configuration. The security credential configuration may indicate whether security credential information is provided in a service. For example, according to various kinds of service, the service may be processed or performed by different entities (e.g., different network operators, different service providers, or a network operator and a service provider), and security credential information may be required for the identification or authentication when the content of the service is exchanged between different entities. Because the security credential information may need to be exchanged by the network operators or the service providers, such configuration may be provided to the UE.

In one implementation, the security credential information provided by the network operators or service providers may include privacy requirements, such as user identification information or authentication information. In another implementation, the security credential information may include at least one of a certificate, a public key and a cryptographic nonce. The security credential information may be provided by a network operator, a third party's MEC application service, a network operator's MEC application service, or a third party's cloud application service.

In some implementations, the security credential configuration may include a security credential policy. The security credential policy may indicate the type of security credential information needed in the network slice. In an example, the security credential policy indicates that the security credential information is from a network operator. In another example, the security credential policy may indicate that the security credential information is from a third party's MEC application service. For example, a video streaming provided by Netflix may be performed on a MEC node provided by AT&T. In another example, the security credential policy may indicate that the security credential information is from a network operator's MEC application service (e.g., a video streaming being provided by AT&T and performed on the network node provided by AT&T). In this case, the AT&T's credentials for the video streaming service may be the same or different from the security credential information for radio access. In yet another example, the security credential policy may indicate that the security credential information is from a third party cloud application service. For instance, Netflix runs video streaming from a server in a cloud node, and the security credential information for the Netflix's video streaming from the cloud node may be the same or different from that for the Netflix's video streaming hosted in a MEC node when both the MEC node and the cloud node are hosted at the same time.

In one implementation, the network slice profile may further include a re-routing configuration to indicate the re-routing policy for the network slice. For example, the re-routing configuration may indicate whether a re-routing procedure is allowed or not. In an example, the re-routing policy may indicate whether a processing node is allowed to be re-routed from a MEC node to a cloud node. In another example, the re-routing policy may indicates whether a processing node is allowed to be re-routed from a cloud node to a MEC node. If the re-routing procedure is allowed, a re-routing of data traffic may take place when a preset condition is satisfied. The preset condition may be configured based on, for example, computational capabilities of network nodes, Quality of Service (QoS) and/or Quality of Experience (QoE) requirements.

Take a network slice with a computational configuration of edge-only computing for example, if the re-routing procedure is allowed, data traffic may be re-routed from an edge node to a cloud node if the edge node finds that it is overloaded and/or cannot provide an assurance on a QoS/QoE level.

In one implementation, to adapt to the re-routing configuration, the security credential configuration may include security credential information of all network nodes involved in the re-routing policy defined in the re-routing configuration. For example, the security credential configuration for the network slice may include security credential information of both the edge node and the cloud node.

In another implementation, the re-routing configuration may indicate whether a virtual machine migration or a computation task migration is allowed or not. In some implementations, the re-routing configuration may indicate whether a virtual machine migration policy or a computation task migration policy is allowed or not. For example, the virtual machine migration policy indicates that the virtual machine or the computation task is migrated from a fog node to a cloud node, and the re-routing configuration may indicate that the virtual machine migration from a fog node to a cloud node is allowed. In another example, the re-routing policy indicates which type of re-routing is allowed in the network slice. For example, the re-routing configuration may be realized as an indication (e.g., a binary flag) to indicate that a virtual machine migration or a computation task migration from an edge node to a core cloud node is allowed, and/or indicate that the migration from a service cloud node to a core cloud node is allowed.

In some implementations, the network slice profile may further include network configurations. For example, the network configuration may include SLA requirements and/or network characteristics (e.g., data rate, communication delay and jitter).

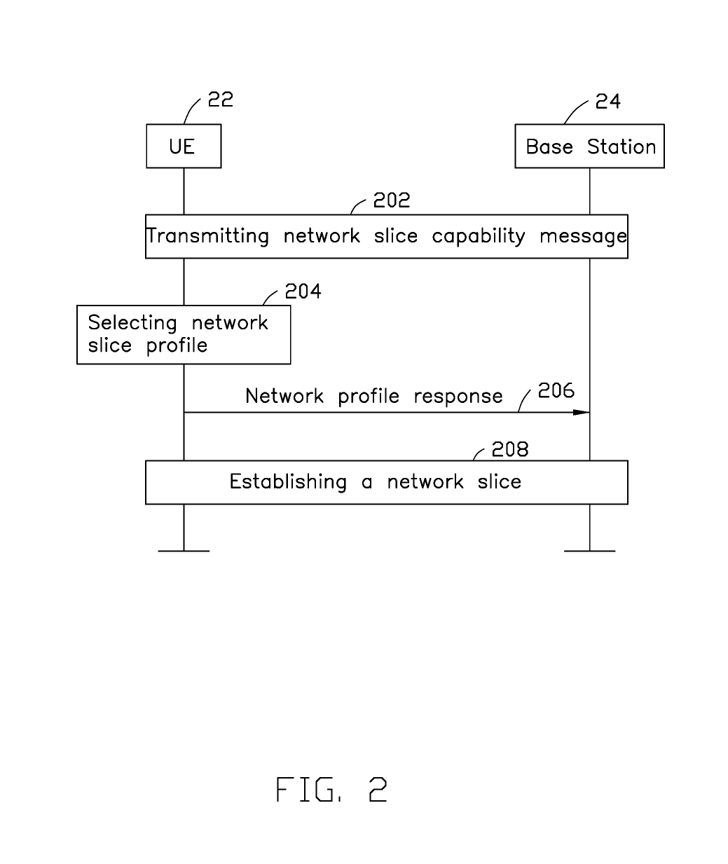

FIG. 2 is a diagram illustrating a method for network slicing, in accordance with an example implementation of the present disclosure. As shown in FIG. 2, a wireless communication system includes a UE 22 and a base station 24. Although in FIG. 2 the wireless communication system includes a UE 22 and a base station 24, one of ordinary skill in the art may appreciate that the wireless communication system may include multiple UEs and base stations.

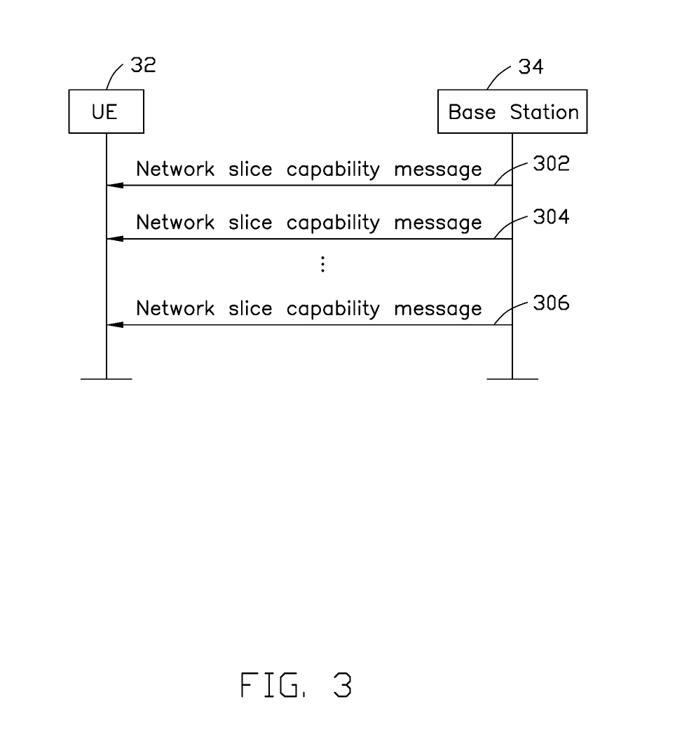

In action 202, the base station 24 transmits one or more network slice capability messages to the UE 22. Details of the transmission procedure will be discussed with reference to at least FIGS. 3, 4 and 5.

In action 204, the UE 22 selects a network slice profile from the network slice capability message. For example, the network slice capability message may include a plurality of candidate network slice profiles with each of which corresponding to the configuration of a network slice. The UE 22 may select a network slice profile that meets certain service requirements. For example, the UE 22 may select a network slice profile that supports an edge-only computational service for a low-latency service requirement. In another implementation, the UE 22 may build no network slice connection with the base station 24 by, for example, replying a message with NACK to the base station 24. In another implementation, the UE 22 may be assigned with a network slice profile by the base station 24.

In action 206, the UE 22 transmits a network profile response to the base station 24. The network profile response may include an indication of the selection result (e.g., slice ID/slice type of the selected network slice) provided in action 204.

In action 208, the UE 22 may communicate with the base station 24 to establish a connection to the selected network slice. Once the connection establishment is completed, the UE 22 may then be served by the selected network slice.

FIG. 3 is a diagram illustrating a method for network slicing during a transmission procedure of network slice capability messages, according to an example implementation of the present disclosure. As shown in FIG. 3, the wireless communication system may include a UE 32 and a base station 34. The UE 32 and the base station 34 may substantially correspond to the UE 22 and the base station 24, respectively, as shown and described with reference to FIG. 2.

In the present implementation, the base station 34 may transmit the network slice capability message by broadcasting the network slice capability message periodically. As shown in actions 302, 304 and 306, the base station 34 broadcasts the network slice capability message to the UE 32 (and other UEs in the coverage area of the cell under control of the base station 34, if any) periodically. The content of each network slice capability message may be the same or different.

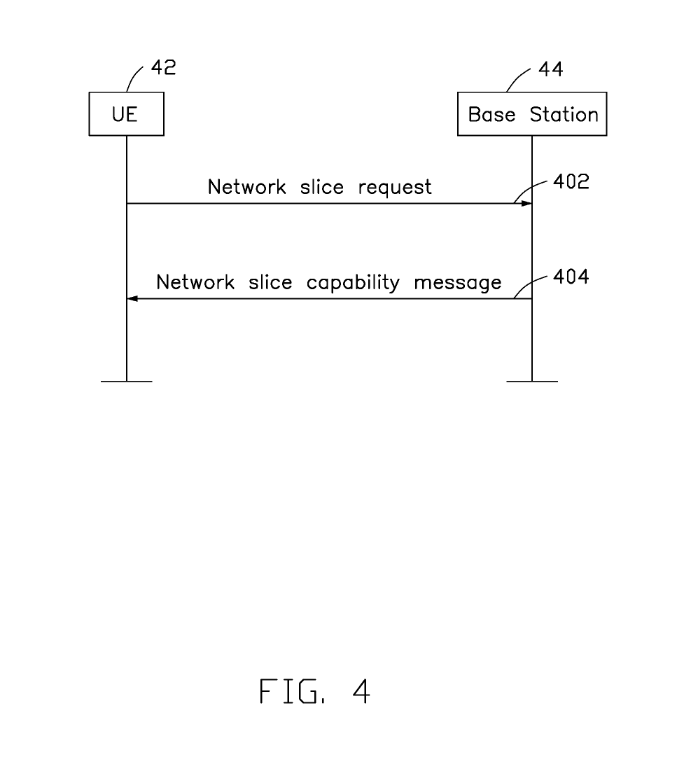

FIG. 4 is a diagram illustrating a method for network slicing during a transmission procedure of network slice capability messages, according to an example implementation of the present disclosure. In the present implementation, the wireless communication system may include a UE 42 and a base station 44. The UE 42 and the base station 44 may substantially correspond to the UE 22 and base station 24, respectively, as shown and described with reference to FIG. 2.

In the present implementation, the base station 44 may generate the network slice capability message in response to a network slice request from the UE 42, and transmit the network slice capability message to the UE 42. As shown in FIG. 4, in action 402, the UE 42 may send a network slice request to the base station 44 on a specific wireless channel. On the other hand, the base station 44 monitors the wireless channel for the network slice request from UE(s). In action 404, the base station 44 may reply the UE 42 with the network slice capability message in response to the received network slice request. The network slice capability message may or may not include one or more network slice profiles indicated by the UE 42. For example, if the network slice request is accepted, the base station 44 may reply the UE 42 with a network slice capability message including the indicated network slice profile. On the contrary, if the network slice request is rejected, the base station 44 may not reply the network slice capability message to the UE 42. In such case, the base station 44 may, for example, reply a message with NACK to the UE 42.

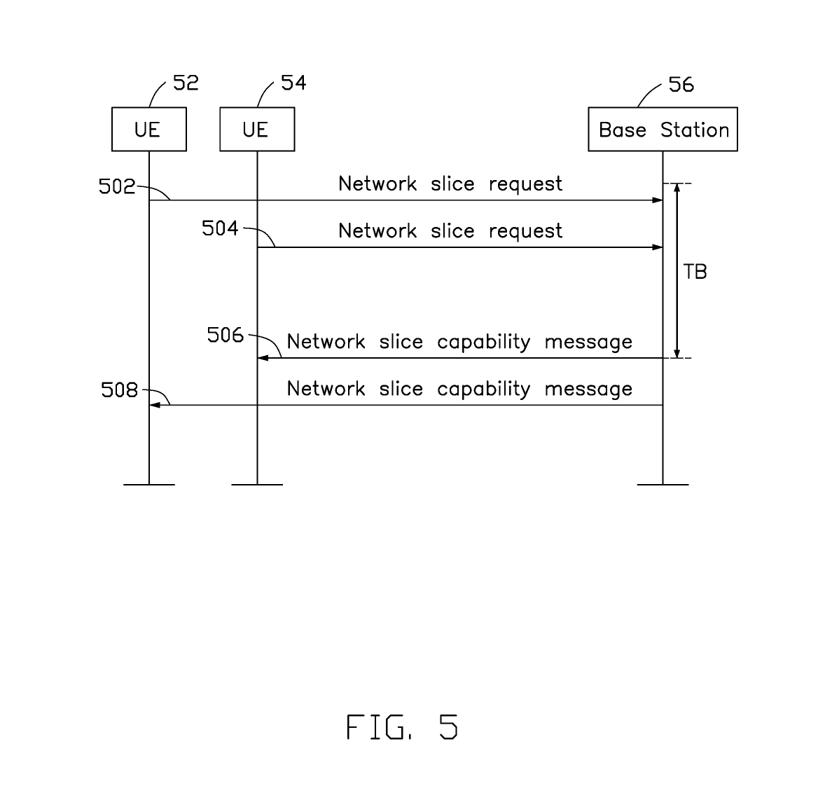

FIG. 5 is a diagram illustrating a method for network slicing during a transmission procedure of network slice capability messages, according to an example implementation of the present disclosure. In the present implementation, the wireless communication system may include a UE 52, a UE 54 and a base station 56. The UE 52 and the UE 54 shown in FIG. 5 may each correspond to the UE 22 shown in FIG. 2. The base station 56 may substantially correspond to the base station 24.

In the present implementation, the base station 56 may monitor the radio channel during a batch handling period of time TB, for collecting the network slice requests sent from the respective UEs (e.g., UE 52 and UE 54) located in the coverage area of the cell. The base station 56 may then generate the network slice capability message in response to all of the collected network slice requests, and transmit the network slice capability message to the requested UEs (e.g., UE 52 and UE 54) in a multicasting or broadcasting manner.

As shown in FIG. 5, during the batch handling period of time TB, the base station 56 may receive one network slice request (hereafter referred to as “first network slice request”) from the UE 52 in action 502, and receive another network slice request (hereafter referred to as “second network slice request”) from the UE 54 in action 504.

In action 506, after the batch handling period of time TB, the base station 56 may multicast or broadcast the network slice capability messages to the UEs 52 and 54. In this implementation, the base station 56 may generate the network slice capability message based on the first and second network slice requests. For example, the network slice capability message may include at least one network slice profile of network slice(s) indicated by the first and second network slice requests.

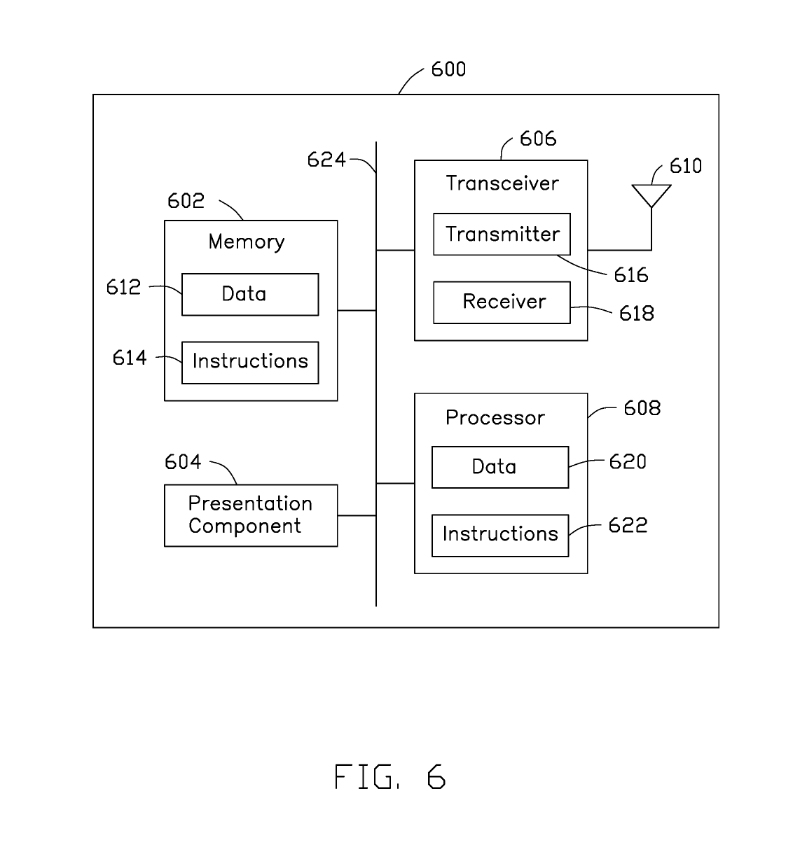

FIG. 6 illustrates a block diagram of a node for wireless communication, in accordance with various aspects of the present application.

As shown in FIG. 6, the node 600 may include a transceiver 606, a processor 608, a memory 602, one or more presentation components 604, and at least one antenna 610. The node 600 may also include an RF spectrum band module, a base station communications module, a network communications module, and a system communications management module, input/output (I/O) ports, I/O components, and power supply (not explicitly shown in FIG. 6). Each of these components may be in communication with each other, directly or indirectly, over one or more buses 624.

The transceiver 606 having a transmitter 616 and a receiver 618 may be configured to transmit and/or receive time and/or frequency resource partitioning information. In some implementations, the transceiver 606 may be configured to transmit in different types of subframes and slots including, but not limited to, usable, non-usable and flexibly usable subframes and slot formats. The transceiver 606 may be configured to receive data and control channels.

The node 600 may include a variety of computer-readable media. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media.

The memory 602 may include computer-storage media in the form of volatile and/or non-volatile memory. The memory 602 may be removable, non-removable, or a combination thereof. Example memory includes solid-state memory, hard drives, optical-disc drives, and etc. As illustrated in FIG. 6, the memory 602 may store data 612 and computer-readable, computer-executable instructions 614 (e.g., software codes) that are configured to, when executed, cause the processor 608 to perform various functions described herein. Alternatively, the instructions 614 may not be directly executable by the processor 608 but be configured to cause the node 600 (e.g., when compiled and executed) to perform various functions described herein.

The processor 608 may include an intelligent hardware device, e.g., a central processing unit (CPU), a microcontroller, an ASIC, etc. The processor 608 may include memory. The processor 608 may process data 620 and instructions 622 received from the memory 602, and information through the transceiver 606, the base band communications module, and/or the network communications module. The processor 608 may also process information to be sent to the transceiver 606 for transmission through the antenna 610.

One or more presentation components 604 presents data indications to a person or other device. Example one or more presentation components 604 include a display device, speaker, printing component, vibrating component, etc.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method comprising:
generating, by a base station, a network slice capability message comprising a network slice profile having a computational configuration; and
transmitting, by the base station, the network slice capability message to a user equipment (UE).

2. The method according to claim 1, wherein the network slice capability message is transmitted to the UE by broadcasting the network slice capability message to at least one UE periodically.

3. The method according to claim 1, further comprising:
receiving, by the base station, a network slice request from the UE, wherein the network slice capability message is generated in response to the network slice request, and the network slice capability message includes at least one network slice profile.

4. The method according to claim 1, further comprising:
receiving, by the base station, a first network slice request from the UE in a batch handling period; and
receiving, by the base station, a second network slice request from another UE in the batch handling period;
wherein the network slice capability message is generated in response to the first network slice request and the second network slice request and is multicast to the UE and the another UE.

5. The method according to claim 1, wherein the computational configuration includes a processing node type for a service.

6. The method according to claim 1, wherein the computational configuration includes a service type.

7. The method according to claim 1, wherein the computational configuration includes a service provider identifier for a service.

8. The method according to claim 1, wherein the network slice profile further comprises a re-routing configuration indicating whether a network slice supports a re-routing procedure.

9. The method according to claim 1, wherein the network slice profile further comprises a security credential configuration.

10. A method comprising:
receiving, by a user equipment (UE), a network slice capability message from a base station, wherein the network slice capability message comprises a network slice profile including a computational configuration; and
establishing, by the UE, a connection to a network slice in response to the network slice capability message.

11. The method according to claim 10, wherein the network slice capability message is received from the base station periodically.

12. The method according to claim 10, further comprising:
transmitting, by the UE, a network slice request to the base station to request the network slice capability message.

13. The method according to claim 10, wherein the network slice capability message includes a plurality of candidate network slice profiles, each candidate network slice profiles includes the computational configuration, and the method further comprises:
selecting, by the UE, the network slice in response to the computational configurations of the candidate network slice profiles.

14. The method according to claim 10, wherein the computational configuration includes a processing node type for a service.

15. The method according to claim 10, wherein the computational configuration includes a service type.

16. The method according to claim 10, wherein the computational configuration includes a service provider identifier for a service.

17. The method according to claim 10, wherein the network slice profile further comprises a re-routing configuration indicating whether the network slice supports a re-routing procedure.

18. The method according to claim 10, wherein the network slice profile further comprises a security credential configuration.

19. A base station comprising:
one or more non-transitory computer-readable media having computer-executable instructions embodied thereon; and
at least one processor coupled to the one or more non-transitory computer-readable media, and configured to execute the computer-executable instructions to:
generate a network slice capability message comprising a network slice profile having a computational configuration; and
transmit the network slice capability message to a user equipment (UE).

20. The base station according to claim 19, wherein the network slice capability message is transmitted to the UE by the base station by broadcasting the network slice capability message to at least one UE periodically.

21. The base station according to claim 19, wherein the at least one processor is further configured to execute the computer-executable instructions to:
receive a network slice request from the UE, wherein the network slice capability message is generated in response to the network slice request, and the network slice capability message includes at least one network slice profile.

22. The base station according to claim 19, wherein the at least one processor is further configured to execute the computer-executable instructions to:
receive a first network slice request from the UE in a batch handling period; and
receive a second network slice request from another UE in the batch handling period;
wherein the network slice capability message is generated in response to the first network slice request and the second network slice request and is multicast to the UE and the another UE.

23. The base station according to claim 19, wherein the computational configuration includes a processing node type for a service.

24. The base station according to claim 19, wherein the computational configuration includes a service type.

25. The base station according to claim 19, wherein the computational configuration includes a service provider identifier for a service.

26. The base station according to claim 19, wherein the network slice profile further comprises a re-routing configuration indicating whether the network slice supports a re-routing procedure.

27. The base station according to claim 19, wherein the network slice profile further comprises a security credential configuration.

28. A user equipment (UE) comprising:
one or more non-transitory computer-readable media having computer-executable instructions embodied thereon; and
at least one processor coupled to the one or more non-transitory computer-readable media, and configured to execute the computer-executable instructions to:
receive a network slice capability message from a base station, the network slice capability message comprising a network slice profile including a computational configuration; and
establish a connection to a network slice in response to the network slice capability message.

29. The UE according to claim 28, wherein the network slice capability message is received from the base station periodically.

30. The UE according to claim 28, wherein the at least one processor is further configured to execute the computer-executable instructions to:
transmit a network slice request to the base station to request the network slice capability message.

31. The UE according to claim 28, wherein the network slice capability message includes a plurality of candidate network slice profiles, each candidate network slice profiles includes the computational configuration, and the at least one processor is further configured to execute the computer-executable instructions to:
select the network slice in response to the computational configurations of the candidate network slice profiles.

32. The UE according to claim 28, wherein the computational configuration includes a processing node type for a service.

33. The UE according to claim 28, wherein the computational configuration includes a service type.

34. The UE according to claim 28, wherein the computational configuration includes a service provider identifier for a service.

35. The UE according to claim 28, wherein the network slice profile further comprises a re-routing configuration indicating whether the network slice supports a re-routing procedure.

36. The UE according to claim 28, wherein the network slice profile further comprises a security credential configuration.
